(19) United States
(12) Patent Application Publication
(10) Pub. No.: US 2009/0094374 A1
(43) Pub. Date: Apr. 9, 2009

(54) SYSTEMS AND METHODS PROVIDING LISTS OF AVAILABLE STREAMING CONTENT

(75) Inventors: Tak W. Lam, Hong Kong (CN); Chun Y. Ng, Hong Kong (CN); Ka Y. Lee, Hong Kong (CN)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (CN)

(21) Appl. No.: 11/867,323

(22) Filed: Oct. 4, 2007

(51) Int. Cl. G06F 15/16

(52) U.S. Cl. 709/231

(57) ABSTRACT

A server for streaming media includes a functional module operable to perform the following functions within a Real Time Streaming Protocol (RTSP) session: receiving a command that requests a list of available streaming presentation options; and generating and transmitting the requested list over a network connection.

### TECHNICAL FIELD

The description herein relates to packet-based streaming and, more specifically, to requesting and providing lists of media content.

### BACKGROUND OF THE INVENTION

Recently, media streaming to personal computers and some hand-held devices has become quite common. Over the Internet, media streaming is used to provide music, movies, voice communication, and the like in real time.

One popular technique to provide streaming media is to employ Real Time Streaming Protocol (RTSP). RTSP is a protocol for use in streaming media systems, and it allows a client to control a server by sending commands. Typical RTSP systems use Real-time Transport Protocol (RTP) as the transport protocol for the audio/video/text data, while RTSP is generally used for command and control.

In a typical RTSP streaming scenario, the client discovers available media through use of a website or other source that is different from the server program that provides the actual content. In one example, a user clicks on a link found on a website that indicates that a movie stream is available. Through one or more transactions, a client on the user's machine is provided with a Uniform Resource Locator (URL) that leads the client to the movie content stored on a server. However, clients do not request lists of available movies, music tracks, etc., from the servers, and servers are not currently operable to handle requests for lists of such content.

Moreover, it is a common occurrence that a user who is receiving streaming content decides to switch to another stream. In RTSP, such switching is usually performed in the following way. The user causes the RTSP session to tear down, thereby closing the Transmission Control Protocol (TCP) socket and also ending the specific RTP stream. The user then clicks on another link on the same or a different website. Clicking on the link leads to a series of transactions wherein the client and server (either the same server or a different server) set up a new RTSP session with a new TCP socket. During the session, the new media stream is provided in an RTP stream. In other words, switching from one stream to another incurs some cost in time and continuity because an entirely new RTSP session must be initiated and a new TCP socket opened.

### BRIEF SUMMARY OF THE INVENTION

Various embodiments of the present invention are directed to systems, methods, and computer program products in which a client is operable to send a request to a server for a list of available media, to receive the requested list, and to select media from the list. Similarly, other embodiments of the invention are directed to systems, methods, and computer program products in which a server is operable to receive a request for a list of available content, provide the list in response to the request, and to receive and process selections made from the list.

In one example embodiment, a client uses an RTSP command to request a list of available content from a server, and the reply to the command includes the requested list. The client can parse the list to look for available content from the server. The client can then use another RTSP command to inform the server of a selection of media from the list.

In another example embodiment, a server receives an RTSP command from a client, wherein the RTSP command includes a request for a list of available content. If possible, the server replies to the command with a list of content. If the client makes a selection from the list, the server receives another RTSP command that indicates the selection. In either embodiment, the server and client may have one or more other exchanges of RTSP requests to setup, play, pause, stop, or select another media stream.

In the above example embodiments, the client is aware of available media on the server and can send a request for other content to the server. The client can use this information to request another stream from the list within the same RTSP session and TCP socket. Accordingly, in many instances, the server and client can change from one stream to another without tearing down the RTSP session or closing the TCP socket.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system adapted according to one embodiment of the invention;

FIG. 2 is an exemplary signal diagram according to one embodiment of the invention;

FIG. 3 is an illustration of an exemplary method adapted according to one embodiment of the invention;

FIG. 4 is an illustration of an exemplary method adapted according to one embodiment of the invention; and

FIG. 5 illustrates an example computer system adapted according to embodiments of the present invention.

### DETAILED DESCRIPTION OF THE INVENTION

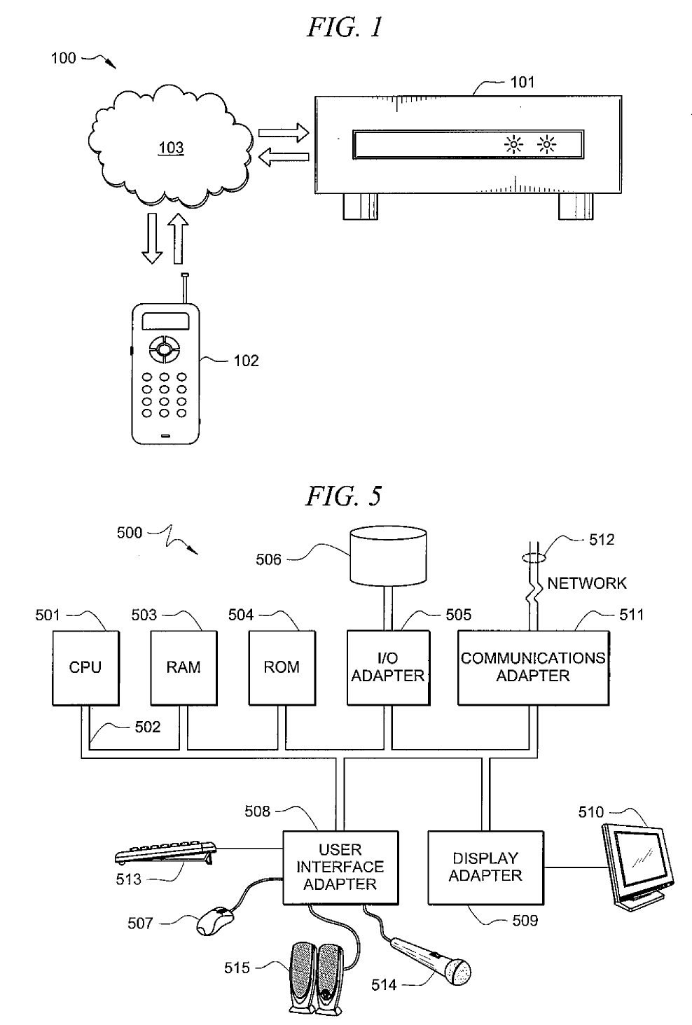

FIG. 1 is an illustration of exemplary system 100 adapted according to one embodiment of the invention. System 100 includes server 101 and client 102, which communicate over network 103.

Server 101 includes a variety of streaming media that are available for access by clients, such as client 102. In some embodiments, server 101 includes a Set Top Box (STB) component that receives Radio Frequency (RF) signals and creates streams therefrom. An example of such an STB is the Home Media Center Platform, available from Hong Kong ASTRI™. However, server 101 is not limited thereto, as various embodiments may include any of a variety of components, such as personal computers, server-type computers, and the like, which are operable to provide live or recorded content as a media stream over network 103.

Client 102 can include a multi-media enabled cellular telephone, a personal computer, a server-type computer, and the like. In this example, network 103 includes a packet switched network, such as the Internet, a Local Area Network (LAN), a cellular network, and the like. In many embodiments, server 101 and client 102 communicate over a plurality of networks during a communication session. For instance, in one example, server 101 is connected to a router using an IEEE 802.11 wireless connection, where the router leads to the internet and to a cellular telephone network that services client 102.

In system 100, at least some of the communication is performed via the Real Time Streaming Protocol (RTSP). RTSP is a protocol for use in streaming media systems, and it allows a client, such as client 102, to control a server, such as server 101, by issuing commands thereto. Typical RTSP systems use Real-time Transport Protocol (RTP) as the transport protocol for the audio/video/text data, and RTSP is generally used for command and control. However, the invention is not limited thereto, as various embodiments can use a variety of transport protocols for multi-media data, such as, e.g., Transport Stream (ISO13818:1) or other proprietary protocols. The type of transport protocol to be used is negotiated in the DESCRIBE step in an RTSP session, and with many embodiments, any proprietary protocol may be used as long as both the server 101 and the client 102 understand it.

In system 100, client 102 is operable to send a request to server 101 for a list of available media presentations for streaming. For example, client 102 is operable to send a RTSP-based request to server 101 to inquire about the available content. After having received the request, server 101 returns a list of, e.g., five movies that are available for viewing.

Such feature is a marked departure from previous RTSP systems. For instance, previous RTSP systems assume that the client knows which streaming media is available through, e.g., accessing a website that lists the media. However, servers in such legacy systems are not operable to list their own content, nor are clients operable to ask for the list of content.

It should be noted that RTSP includes a DESCRIBE command that usually includes an aggregate URL of a selected stream, wherein the selected stream (e.g., a movie) may include an audio stream component, a video stream component, and a text stream component that are all under the aggregate URL. The server responds to the DESCRIBE command by listing the video, audio, and text streams controlled within the aggregate URL. However, such feature is different from the added functionality of various embodiments of the present invention. For example, the DESCRIBE command only lists streams within an aggregate stream that is already selected. By contrast, various embodiments of the present invention allow a client to receive a list of streams before any stream is actually selected. Additionally, the DESCRIBE command requests information about discrete stream components (e.g., audio/video/text) within in an aggregate stream (e.g., a movie). Such discrete stream components are not content-independent because the content of each is dependent on the content of the others in order to produce a full multi-media presentation. Various embodiments of the present invention allow the client to request a list of presentations that are content-independent (e.g., a list of movies rather than a list of the components of a single movie). It should be noted, though, that embodiments of the present invention often include DESCRIBE command functionality, as well as the enhanced functionality described herein.

As used herein, the terms “presentation” or “movie” (which may or may not have visual streams) refer to media content available for streaming that may include one or more stream components. Each movie or presentation in a list is content-independent. For instance, a list of content-independent presentations may include five music tracks, three television clips, and a movie broken up into two chronological halves. By contrast, the stream components of the presentations/movies are referred to as “stream components” or “substreams.”

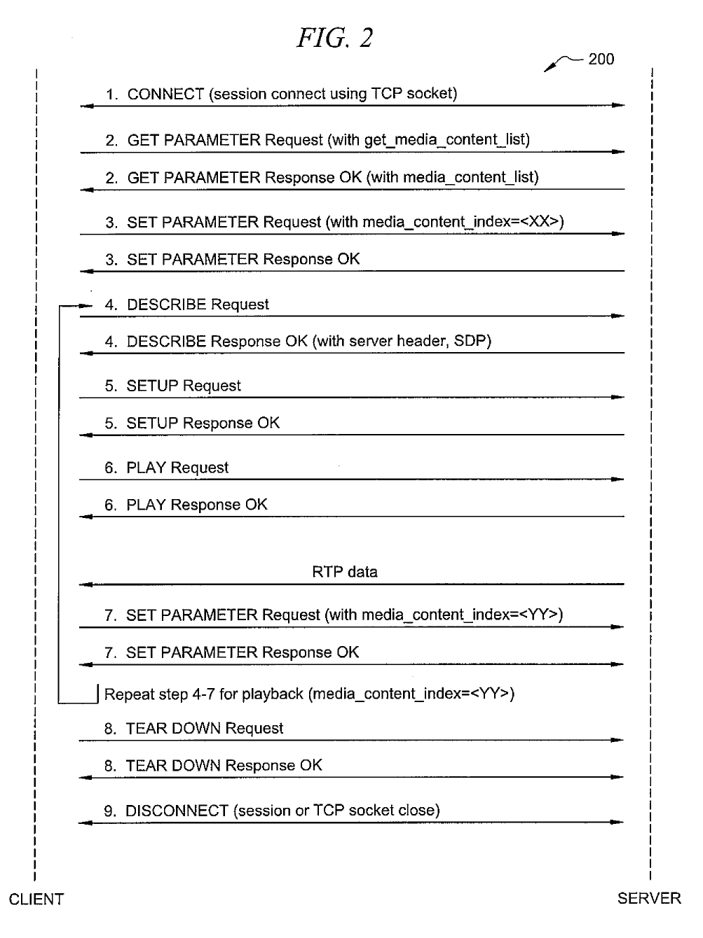

FIG. 2 is an exemplary signal diagram according to one embodiment of the invention. In one example, client 102 and server 101 of system 100 communicate according to the diagram of FIG. 2, as explained below. The communications include packets that are transmitted over a network, such as network 103.

In the first exchange, the server and client establish an RTSP session and connect by using a Transmission Control Protocol (TCP) socket. RTSP is stateful, and the session lasts through a plurality of exchanges until it is disconnected.

In the second exchange, a GET_PARAMETER request is transmitted by the client to the server. In RTSP the GET_PARAMETER request does not have a standard payload. Thus, it is possible to create new commands within GET_PARAMETER. In this example, the client is programmed to send a request that reads:

GET_PARAMETER:get_media_content_list

Additionally, the client is programmed to expect a response that includes the requested list or a response indicating that there is no list available (e.g., a NO response). If there is no list available, the client may simply terminate the session in some circumstances or may request a specific media stream, as in a typical RTSP system.

Also in this example, the server is programmed to understand that the GET_PARAMETER request followed by the get_media_content_list command is an instruction to create a list of available streaming presentations. In some examples, the server queries a database to determine which streams are available and creates the list from the results of that query. In other examples, the server has a pre-made list that it prepares for transmitting in response to receipt of the command. However, the invention is not limited to any particular method for creating the list.

The list can be constructed according to any of a variety of formats, including providing a plurality of indices, each index corresponding to a short media content description of a specific stream. However, the invention is not limited to any particular format of the list. A non-exclusive group of exemplary options for formatting the list includes:

1. The list is signaled by the return code available in the first line on the RTSP response.

2. The response payload specifies the number of presentations available.

3. The number of presentations available is inferred by delimiters or markers separating each presentation description in a list, such that numbers or indices are implied. In many examples, the client saves the list that it receives in a computer readable storage medium, such a RAM, a hard disk, or the like.

In the third exchange the client transmits a SET_PARAMETER request that identifies a presentation from the list. Similar to the GET_PARAMETER request, the SET_PARAMETER request is not limited to a standard payload. In this example, the client is programmed to send a request that reads:

SET_PARAMETER:<XX>

wherein “XX” includes an action such as “switch_to” and an index that corresponds to the selected presentation in the list. For example, XX could be “switch_to 1”. The server is programmed to understand that the index refers to one of the streams that is selected by the client. In response, the server confirms the selection by responding “OK.” If the client's request is invalid or unavailable, the server's response may include, e.g., the return code 404 “Not found” (defined in RTSP standard), or another proprietary return code can be used. In another example, an invalid or unavailable selection can be signaled by a particular payload understood by the server and client (e.g., a NO response). In such case, the client may end the session or may use more typical methods to access media streams (e.g., sending an aggregate URL during a DESCRIBE step).

While specific examples are given above for a format of the GET_PARAMETER/SET_PARAMETER requests and responses, the invention is not limited to any particular format or syntax for the payloads of such commands. In fact, any of a variety of formats and syntaxes can be used in some embodiments. In fact, other embodiments can add custom RTSP commands and/or redefine other existing RTSP commands to serve the same purpose. Therefore the invention is not limited to the use of GET_PARAMETER and SET_PARAMETER, as other commands to achieve the same purpose may be used in various embodiments.

Following the selection of the particular streaming presentation, the server and client have a few short exchanges that are the same as in typical RTSP systems. In other words, the DESCRIBE, SETUP, and PLAY requests and responses can be used in many embodiments without being changed. Thus, in the fourth exchange, the client sends a DESCRIBE request to the server, and the server returns a short description of the selected streaming presentation, usually in Session Description Protocol (SDP) format. As described above, the response to the DESCRIBE request may include a list of the stream components under the aggregate stream (e.g., video and audio stream components in a selected movie stream) and their respective URLs.

The client then sends a SETUP request to the server that specifies how each of the media stream components are to be transported. For example, the transport request typically includes a local port for receiving RTP data and another for control or metadata, sometimes over Real Time Control Protocol (RTCP). The server then replies, usually confirming the parameters and adding any of its own.

In the sixth exchange, the client sends the PLAY request to the server. The play request can include an aggregate URL for the selected streaming presentation, or it can be a stacked PLAY request that includes requests for each of the individual component streams to be played.

Between the sixth and seventh exchanges, the server sets up one or more RTP streams to deliver the content to the client. The RTP streams send the actual data (e.g., audio/video) to the client.

In exchange seven, the client sends another SET_PARAMETER request to the server in order to select a different streaming presentation. The server may or may not end the RTP streams at this point. In fact, the server may wait until the next play request to end the first RTP streams and set up the new RTP streams. The server responds to the SET_PARAMETER request as before (i.e., with an OK or a NO).

The client then sends DESCRIBE, SETUP, and PLAY requests as before. The server sets up the new RTP streams in response to the PLAY request. In this way, the client can switch streaming presentations without having to tear down the RTSP session. However, once the client is through streaming, it can send a TEARDOWN request and cause the TCP connection to be disconnected, thereby ending the RTSP session.

The signal diagram of FIG. 2 shows one exemplary RTSP session. Various embodiments of the invention may diverge from the particulars shown in FIG. 2 by, e.g., adding, omitting, or rearranging requests within the session. Thus, in one example, the client pauses the stream by sending a PAUSE command to the server. In fact, a variety of other RTSP requests not discussed herein can be used in various embodiments. In another embodiment, the client changes media streams more than once or not at all.

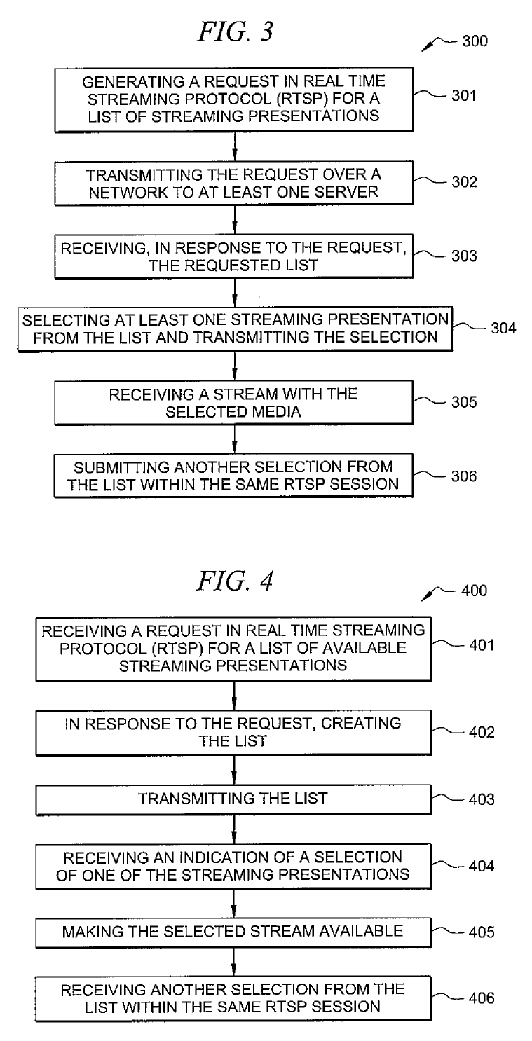

FIG. 3 is an illustration of exemplary method 300 adapted according to one embodiment of the invention. Method 300 may be performed, for example, by a client in an RTSP system created according to an embodiment of the invention. In this example, the client executes code in a computer program that generates a request for a list, understands the response to the request, and selects a stream from the list.

In step 301, the client generates a request in RTSP for a list of streaming presentations. Since the request is for streaming presentations, the appropriate response is either an indication that no list is available or a list of presentations (e.g., movies, music tracks, etc.) that may or may not include more than one stream components. This is in contrast to a DESCRIBE request that may return a list of content-dependent substream components under an aggregate URL.

In step 302, the request is transmitted to a server. The request is transmitted over a network as one or more packets according to, e.g., Internet Protocol (IP), and/or a variety of other protocols. In one example, the client uses a GET_PARAMETER request with a payload that specifies the list request.

In step 303, the client receives the requested list. In some embodiments, the list includes one or more short descriptions of the available streaming presentations. The list may also include indices respectively corresponding to each of the entries in the list to allow a media selection to be made by referring to an index. However, as explained above, a variety of list formats can be used within the scope of embodiments. As part of the receiving, the client may store the list to a computer-readable medium, such as an optical or magnetic storage medium now known or later developed.

In step 304, the client selects at least one presentation from the list. In one example, the client selects a media stream from the list by using a SET_PARAMETER request with a payload that specifies the selection.

In step 305, the client receives a stream (or more than one stream if there are multiple stream components) from the server with the selected media. In one example, the stream is an RTP stream that is set up after a DESCRIBE, SETUP, and PLAY exchange between the server and the client. The client can then present the media to a user by employing a video screen, speakers, and/or the like.

In step 306, the client submits another selection within the same RTSP session by, e.g., using a SET_PARAMETER request, as in step 304. The selection may be followed by another DESCRIBE, SETUP, and PLAY between the client and server. The previous RTP stream (or streams) is torn down, and a new RTP stream (or streams) is created without closing the TCP socket. The client can then present the media stream (or streams) to a user by employing a video screen, speakers, and/or the like. At a later time, the client may send a TEAR_DOWN request, thereby initiating the end to the TCP socket and the RTSP session.

While method 300 is shown as a series of discrete steps, it should be noted that the invention is not limited thereto, as various embodiments of the invention can add, omit, and/or rearrange steps. For instance, the client may (e.g., at the request of the user) switch streaming presentations, as in step 306, multiple times or not at all.

In some embodiments, the client may discern that a received stream is of low quality. In response, the client can then switch to a higher quality stream of the same media content if the list indicates that there is another option. For example, if a movie stream continually “drops out”, the client (or even the user) may then begin to switch to another stream of the same movie in the hope that the new stream is of better quality. It is also possible that the client can present a representation of the list of media to the user through a user interface. In this way, user-directed media selection can be facilitated.

FIG. 4 is an illustration of exemplary method 400 adapted according to one embodiment of the invention. Method 400 may be performed, for example, by a server in an RTSP system created according to an embodiment of the invention. In this example, the server executes code in a computer program that understands a request for a list, generates the list, transmits the list in response to the request, and understands a client selection based on the list.

In step 401, a request is received in RTSP for a list of available streaming presentations. This is in contrast to a DESCRIBE request that may return a list of content-dependent substream components under an aggregate URL.

In step 402, the list is created. Since the request is for content-independent streams, the appropriate response is either a “NO” or a list of streams (e.g., movies, music tracks, etc.) that may or may not include more than one substream component. In one example embodiment, a server receives a GET_PARAMETER request with a payload indicating the list request, and the server is programmed to understand the received command. In response, the server generates the list by querying itself to identify available content. The invention is not limited to any one method of creating the list.

In step 403, the list is transmitted. In one example embodiment, the list is transmitted in a response to the GET_PARAMETER request.

In step 404, an indication of a selection of one of the streams is received. For example, the indication can be received as part of a SET_PARAMETER request with a payload indicating the selection.

In step 405, the selected stream is made available. In one example, the server and client go through a DESCRIBE, SETUP, and PLAY exchange after which the server sets up an RTP stream (or streams) with the requested content.

In step 406, another selection from the list is received. Once again, in this example, the selection is indicated in a SET_PARAMETER request. The selection may be followed by another DESCRIBE, SETUP, and PLAY between the client and server. The previous RTP stream (or streams) is torn down, and a new RTP stream (or streams) is created without closing the TCP socket. At a later time, the client may send a TEAR_DOWN request to the server, thereby initiating the end to the TCP socket and the RTSP session.

While method 400 is shown as a series of discrete steps, it should be noted that the invention is not limited thereto, as various embodiments of the invention can add, omit, and/or rearrange steps. For instance, the server may or may not be called upon to switch streaming presentations, and if it is called upon to switch presentations, it may switch presentations multiple times.

Various embodiments of the present invention may provide one or more advantages over prior art systems. For instance, prior art systems require that an RTSP session, and its TCP socket be torn down before a request for another streaming presentation is made. This is true even if the client requests media from the same server. Thus, the RTP session is torn down, and the TCP socket is closed. The client then initiates the establishment of a new RTSP session and TCP socket, various exchanges are made between the client and server to select and setup a media stream, and a new RTP stream is established.

By contrast, some example RTSP systems according to one or more embodiments can facilitate switching of presentations without having to tear down the TCP session. While there will be a delay tearing down the RTP session and setting up another RTP session, the delay incurred in tearing down and establishing a new RTSP session is eliminated. In embodiments that switch presentations, e.g., to find higher-quality streams, the decreased delay may provide greater user satisfaction.

Another advantage of various embodiments of the invention is that such embodiments do not require a change to the RTSP protocol. Instead, as mentioned above, the GET_PARAMETER and SET_PARAMETER requests are open to the use of proprietary payloads. Further, some clients and servers can be created using existing components. For example, an existing client (e.g., a personal computer) can be programmed to send the GET_PARAMETER and SET_PARAMETER requests (and also to understand the responses) by a simple change of software. Some other clients, such as cellular phones, can be reprogrammed by changing software and/or firmware. Similarly, servers (e.g., STBs) can be reprogrammed through firmware and/or software changes to participate in the exchanges shown in FIG. 2.

When implemented via computer-executable instructions, various elements of embodiments of the present invention are in essence the software code defining the operations of such various elements. The executable instructions or software code may be obtained from a readable medium (e.g., a hard drive media, optical media, RAM, EPROM, EEPROM, tape media, cartridge media, flash memory, ROM, memory stick, and/or the like). In fact, readable media can include any medium that can store information.

FIG. 5 illustrates an example computer system 500 adapted according to embodiments of the present invention. That is, computer system 500 comprises an example system on which embodiments of the present invention may be implemented (such as server 101 and client 102 of the example implementation of FIG. 1). Central processing unit (CPU) 501 is coupled to system bus 502. CPU 501 may be any general purpose CPU. However, the present invention is not restricted by the architecture of CPU 501 as long as CPU 501 supports the inventive operations as described herein. CPU 501 may execute the various logical instructions according to embodiments of the present invention. For example, one or more CPUs, such as CPU 501, may execute machine-level instructions according to the exemplary operational flows described above in conjunction with FIGS. 3 and 4.

Computer system 500 also preferably includes random access memory (RAM) 503, which may be SRAM, DRAM, SDRAM, or the like. Computer system 500 preferably includes read-only memory (ROM) 504 which may be PROM, EPROM, EEPROM, or the like. RAM 503 and ROM 504 hold user and system data and programs, as is well known in the art.

Computer system 500 also preferably includes input/output (I/O) adapter 505, communications adapter 511, user interface adapter 508, and display adapter 509. I/O adapter 505, user interface adapter 508, and/or communications adapter 511 may, in certain embodiments, enable a user to interact with computer system 500 in order to input information, such as media selections.

I/O adapter 505 preferably connects to storage device(s) 506, such as one or more of hard drive, compact disc (CD) drive, floppy disk drive, tape drive, etc. to computer system 500. The storage devices may be utilized when RAM 503 is insufficient for the memory requirements associated with storing media data. Communications adapter 511 is preferably adapted to couple computer system 500 to network 512 (e.g., the Internet, a LAN, a cellular network, etc.). User interface adapter 508 couples user input devices, such as keyboard 513, pointing device 507, and microphone 514 and/or output devices, such as speaker(s) 515 to computer system 500. Display adapter 509 is driven by CPU 501 to control the display on display device 510 to, for example, display a choice of media or to display the media as it is played.

While FIG. 5 shows a general-purpose computer, it should be noted that the exact configuration of a portion of a system according to various embodiments may be slightly different. For example, clients according to one or more embodiments may be any kind of processor-based device, such as a cell phone, a Personal Digital Assistant, a specialized device (e.g., a stand-alone P2P television module, or a Home Media Center available from Hong Kong Applied Science and Technology Research Institute Company Limited, that streams television content), a STB, and/or the like. Additionally, servers according to one or more embodiments may be any kind of processor-based device capable of sending media streams, such as a personal computer, a server-type computer, a STB, a Home Media Center, and the like. Further, various embodiments can implement the server and client in specialized hardware modules or as software modules that are executed on processor-based devices. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A server for streaming media, said server comprising:
a functional module operable to perform the following functions within a Real Time Streaming Protocol (RTSP) session:
receiving a command that requests a list of available streaming presentations; and
generating and transmitting said requested list over a network connection.

2. The server of claim 1 comprising one or more of a set top box and a personal computer.

3. The server of claim 1 wherein the functional module is further operable to receive a selection of a first media presentation from said list and to make said presentation available.

4. The server of claim 3 wherein said functional unit is further operable to receive a selection of a second media presentation within said RTSP session.

5. The server of claim 4 wherein said functional unit is further operable to switch between providing said first and said second media presentations within said RTSP session.

6. A media streaming client, said client comprising:
a functional module operable to perform the following functions within a Real Time Streaming Protocol (RTSP) session:
generating and transmitting a command requesting a list of streaming presentations;
receiving and processing a response to said request, said response including said requested list; and
generating and transmitting a request to play at least one selection from said requested list.

7. The streaming client of claim 6, wherein said functional module displays said requested list within a user interface for selection of media by a user.

8. The streaming client of claim 6, wherein said functional module generates and transmits a request to play at least one other selection from said requested list without requesting a teardown of said RTSP session.

9. The streaming client of claim 6 wherein said requested list includes a plurality of entries, each of said entries selectable using an associated with a respective index.

10. The streaming client of claim 9, wherein said functional module identifies said at least one selection from said list and sends a request for a description of said selection before generating and transmitting said play request.

11. The streaming client of claim 6 comprising one or more of a cellular telephone, a personal computer, and a set top box.

12. A method for receiving multi-media content, said method comprising:
generating one or more first packets of data that include a request in Real Time Streaming Protocol (RTSP) for a list of available streaming presentations;
transmitting said one or more first packets over a network to at least one server;
receiving, in response to said request, one or more second packets of data that include said requested list;
selecting a first streaming presentation from said list; and
generating and transmitting one or more third packets of data indicating said selection.

13. The method of claim 12 further comprising receiving said selected first streaming presentation.

14. The method of claim 13 further comprising generating and transmitting one or more fourth packets of data indicating said a selection of a second streaming presentation from said list within a same RTSP session as said generation of said first packets.

15. The method of claim 14 further comprising receiving said selected first streaming presentation within said RTSP session.

16. A method for providing multi-media content, said method comprising:
receiving one or more first packets of data over a network, said first packets including a request in Real Time Streaming Protocol (RTSP) for a list of available streaming presentations;
in response to said request, creating said list;
generating and transmitting one or more second packets of data that include said list;
receiving one or more third packets of data including an indication of a selection of a first one of said streams;
making said selected first stream available.

17. The method of claim 16 further comprising receiving one or more fourth packets of data including an indication of a selection of a second one of said streams.

18. The method of claim 17 further comprising making said second stream available within a same RTSP session as said reception of said first packets.
